(19) United States
(12) Patent Application Publication
(10) Pub. No.: US 2015/0280266 A1
(43) Pub. Date: Oct. 1, 2015

(54) BIOFUEL CELL, METHOD FOR PRODUCTION OF BIOFUEL CELL, ELECTRONIC DEVICE, ENZYME IMMOBILIZATION ELECTRODE, METHOD FOR PRODUCTION OF ENZYME IMMOBILIZATION ELECTRODE, ELECTRODE FOR PRODUCTION OF ENZYME IMMOBILIZATION ELECTRODE, METHOD FOR 5 PRODUCTION OF ELECTRODE FOR PRODUCTION OF ENZYME IMMOBILIZATION ELECTRODE AND ENZYME REACTION USING DEVICE

(71) Applicant: Sony Corporation, Tokyo (JP)

(72) Inventors: Takaaki Nakagawa, Kanagawa (JP); Kenichi Murata, Kanagawa (JP); Tsunetoshi Samukawa, Kanagawa (JP); Shuji Fujita, Tokyo (JP); Hiroki Mita, Kanagawa (JP); Harumi Takada, Kanagawa (JP)

(21) Appl. No.: 14/353,731

(22) PCT Filed: Oct. 25, 2012
(86) PCT No.: PCT/JP2012/077632

§ 371 Date: Apr. 23, 2014

(30) Foreign Application Priority Data
Nov. 2, 2011 (JP) 2011-240783

(51) Int. Cl. H01M 8/16; G01N 27/327; H01M 4/86

(52) U.S. Cl. CPC H01M 8/16; H01M 4/8668; H01M 4/8673; G01N 27/327; H01M 2250/30; H01M 2250/20

(57) ABSTRACT

Provided are an enzyme immobilization electrode capable of easily immobilizing an enzyme while retaining activity, an electrode for production of an enzyme immobilization electrode which is suitably used for production of the enzyme immobilization electrode, and a biofuel cell using the enzyme immobilization electrode.

In a biofuel cell having a structure in which a positive electrode and a negative electrode face each other with a proton conductor interposed therebetween, and configured to extract an electrode from a fuel using an enzyme, an electrode which includes a mixture containing carbon particles and a water-insoluble hydrophilic binder and on which the enzyme is immobilized is used for at least one of the positive electrode and the negative electrode. Ketjen black or the like is used for carbon particles, and ethyl cellulose or the like is used for the binder.

### TECHNICAL FIELD

The present disclosure relates to a biofuel cell, a method for production of a biofuel cell, an electronic device, an enzyme immobilization electrode, a method for production of an enzyme immobilization electrode, an electrode for production of an enzyme immobilization electrode, a method for production of an electrode for production of an enzyme immobilization electrode and an enzyme reaction using device. More specifically, the present disclosure is suitably applied to, for example, a biofuel cell, a biosensor and a bioreactor or the like, a method for production thereof, an enzyme immobilization electrode which is suitably used therefor and a method for production thereof, or various kinds of electronic devices using a biofuel for a power supply.

### BACKGROUND ART

In recent years, biofuel cells using an enzyme have received attention (see, for example, Patent Documents 1 to 12). The biofuel cell separates a fuel into protons (H⁺) and electrons by degrading the fuel by an enzyme, and those using as a fuel an alcohol such as methanol or ethanol or a monosaccharide such as glucose or a polysaccharide such as starch is developed.

As electrodes of biofuel cells, carbon fiber electrodes that are porous electrodes, and carbon papers is generally used heretofore for increasing the effective surface area. However, these electrodes have the problem that it is difficult to take any desired shape, and a pressure should be applied to form a structure of a power supply unit, i.e. a membrane electrode assembly (MEA), thus raining complication. In such a membrane electrode assembly, the thickness of the electrode is fixed, and therefore it is very difficult to form an electrode having a thickness of, for example, 100 μm or less.

On the other hand, in conventional general fuel cells, a membrane electrode assembly is formed by mixing as a binder a fluorine-based resin such as that of polyvinylidene fluoride (PVDF), polytetrafluoroethylene (PTFE) or Nafion with a carbon powder.

### CITATION LIST

### Patent Documents

Patent Document 1: Japanese Patent Application Laid-Open (JP-A) No. 2000-133297
Patent Document 2: JP-A No. 2003-282124
Patent Document 3 JP-A No. 2004-71559
Patent Document 4: JP-A No. 2005-13210
Patent Document 5: JP-A No. 2005-310613
Patent Document 6: JP-A No. 2006-24555
Patent Document 7: JP-A No. 2006-49215
Patent Document 8: JP-A No. 2006-93090
Patent Document 9: JP-A No. 2006-127957
Patent Document 10: JP-A No. 2006-156354
Patent Document 11: JP-A No. 2007-12281
Patent Document 12: JP-A No. 2007-35437
Patent Document 13: JP-A No. 2008-273816

### SUMMARY OF THE INVENTION

### Problems to be Solved by the Invention

However, when an electrode is formed by mixing a fluorine-based resin with a carbon powder, the obtained electrode becomes water-repellent because the fluorine-based resin is water-repellent. Thus, when this electrode is applied to a biofuel cell, there is the problem that an enzyme is hardly immobilized because an enzyme solution does not penetrate into the electrode at the time of immobilizing the enzyme on the electrode using the enzyme solution, or the enzyme is deactivated.

Thus, an object to be achieved by the present disclosure is to provide an enzyme immobilization electrode capable of easily immobilizing an enzyme while retaining activity of the enzyme and a method for production thereof, and an electrode for production of an enzyme immobilization electrode, which is suitably used for production of the enzyme immobilization electrode.

Another object to be achieved by the present disclosure is to provide a high-performance biofuel cell using the above-mentioned excellent enzyme immobilization electrode and a method for production thereof.

Still another object to be achieved by the present disclosure is to provide a high-performance electronic device using the above-mentioned excellent biofuel cell.

Still another object to be achieved by the present disclosure is to provide a high-performance enzyme reaction using device using the above-mentioned excellent enzyme immobilization electrode.

### Solutions to Problems

In order to achieve the object, according to the present disclosure, there is provided a biofuel cell including:

a positive electrode;

a negative electrode; and

a proton conductor provided between the positive electrode and the negative electrode,

wherein at least one of the positive electrode and the negative electrode is a mixture containing carbon particles and a water-insoluble hydrophilic binder and on which an enzyme is immobilized.

Further, according to the present disclosure, there is provided a method for production of a biofuel cell, wherein for producing a biofuel cell including:

a positive electrode;

a negative electrode; and

a proton conductor provided between the positive electrode and the negative electrode,

the method includes the steps of:

forming an electrode from a mixture containing carbon particles and a water-insoluble hydrophilic binder; and

forming at least one of the positive electrode and the negative electrode by immobilizing an enzyme on the electrode.

Further, according to the present disclosure, there is provided an electronic device,

the electronic device using one or plural fuel cells,

at least one fuel cell being a biofuel cell including:

a positive electrode;

a negative electrode; and

a proton conductor provided between the positive electrode and the negative electrode,

wherein at least one of the positive electrode and the negative electrode is a mixture containing carbon particles and a water-insoluble hydrophilic binder and on which an enzyme is immobilized.

In the present disclosure, carbon particles includes, for example, at least one selected from the group consisting of carbon black, bio-carbon and vapor phase process carbon fiber, but other materials, for example activated carbon, may be used. Examples of carbon black include furnace black, acetylene black, channel black, thermal black and ketjen black, and among them, ketjen black is preferred. Bio-carbon is a porous carbon material which has as a raw material a plant-derived material having silicon content of 5% by mass or more and which has a specific surface area value of 10 m²/g or more as measured by a nitrogen BET method, a silicon content of 1% by mass or more and a pore volume of 0.1 cm³/g or more as measured by a BJH method or MP method (see Patent Document 13). Specifically, bio-carbon is prepared, for example, in the following manner. That is, first, ground rice hulls (rice hulls of Isehikari produced in Kagoshima Prefecture) were carbonized at 500° C. for 5 hours in a nitrogen gas stream to obtain a carbide. Thereafter, 10 g of the carbide was put in a crucible made of alumina, and heated to 1000° C. at a temperature elevation rate of 5° C./minute in a nitrogen gas stream (10 liters/minute). The carbide was carbonized at 1000° C. for 5 hours to be converted into a carbonaceous substance (porous carbon material precursor), and then cooled to room temperature. A nitrogen gas was continuously passed during carbonization and cooling. Next, the porous carbon material precursor was immersed in 46% by volume of an aqueous hydrofluoric acid solution overnight to be acid-treated, and then washed with water and ethyl alcohol until pH 7 was attained. Finally the porous carbon material precursor was dried to obtain a porous carbon material, i.e. bio-carbon. The vapor phase process carbon fiber is, for example, VGDF (trademark of Showa Denko K.K.). Examples of activated carbon include wood charcoals such as oak charcoal, sawtooth oak charcoal, Japanese oak charcoal and Japanese cypress charcoal, and rubber charcoal, bamboo charcoal, sawdust char coal and coconut shell charcoal. The water-insoluble hydrophilic binder is selected as necessary from those that are previously well-known, but is preferably, for example, at least one selected from the group consisting of ethyl cellulose, polyvinyl butyral, an acrylic resin and an epoxy resin. The mixture containing carbon particles and a water-insoluble hydrophilic binder may contain one or two or more other components in addition to carbon particles and a water-insoluble hydrophilic binder as necessary. Typically a ratio of a mass (weight) of a water-insoluble hydrophilic binder to a mass (weight) of carbon particles in the mixture is 0.01 or more and 1 or less, but the ratio is not limited thereto.

For forming an electrode including a mixture containing carbon particles and a water-insoluble hydrophilic binder, typically a paste containing carbon particles and a water-insoluble hydrophilic binder is prepared, the paste is applied onto a substrate, and the paste is then solidified. Asa solvent for preparing the paste, for example, an organic solvent such as methyl isobutyl ketone (MIBK), terpineol or 2-propanol may be used. Besides, various kinds of solvents that are used for inks to be used in printing, for example butyl carbitol acetate, butyl carbitol and methyl ethyl ketone may be used as the solvent. When an enzyme and an electron mediator are dispersed in an ink at the same time, water or a buffer solution can be mixed, for example, at a ratio of organic solvent:water=100:1 to 1:10, and used. The substrate to which the paste is applied may be basically any substrate, and is appropriately selected from substrates formed of previously well-known materials. By using an electrode integrated with the substrate, the mechanical strength of the electrode can be improved. After an electrode is formed on the substrate, the substrate may be peeled off from the electrode as necessary.

In this biofuel cell, when a separator is provided between a positive electrode and a negative electrode, preferably at least one of the positive electrode and the negative electrode is formed integrally with the separator for simplifying the production process or improving the mechanical strength of the positive electrode or the negative electrode, and more adequately performing proton transfer between the positive electrode and the negative electrode. When a positive electrode and a negative electrode are formed integrally with a separator, one of the positive electrode and the negative electrode is formed on one surface of the separator, and the other one of the positive electrode and the negative electrode is formed on the other surface. Similarly, in a method for production of the biofuel cell, when a separator is provided between a positive electrode and a negative electrode, preferably a paste containing carbon particles and a water-insoluble hydrophilic binder is applied onto the separator, and the paste is then solidified to form at least one of the positive electrode and the negative electrode integrally with the separator. In this case, the separator corresponds to the substrate. As the separator, various kinds of previously well-known separators may be used, and a selection is made as necessary.

For example when a monosaccharide such as glucose is used as a fuel, an enzyme to be immobilized on a negative electrode includes an oxidase which degrades the monosaccharide by accelerating oxidation thereof, and enzyme usually includes, in addition thereto, a coenzyme oxidase which returns to an oxidant a coenzyme reduced by the oxidase. By action of the coenzyme oxidase, an electron is generated when the coenzyme returns to the oxidant, and the electron is delivered to the electrode through an electron mediator from the coenzyme oxidase. For example NAD⁺-dependent-type glucose dehydrogenase (GDH) is used as the oxidase, for example nicotinamide adenine dinucleotide (NAD⁺) is used as the coenzyme, and for example diaphorase is used as the coenzyme oxidase.

When a polysaccharide is used as a fuel, preferably a degrading enzyme which accelerates degradation such as hydrolysis to generate a monosaccharide such as glucose is immobilized in addition to the above-described oxidase, coenzyme oxidase, coenzyme and electron mediator. Here, the polysaccharide is a polysaccharide in a broad sense, refers to all carbohydrates which generate a monosaccharide of two or more molecules when hydrolyzed, and includes oligomers such as disaccharides, trisaccharides and tetrasaccharides. Specific examples of the polysaccharide include starch, amylose, amylopectin, glycogen, cellulose, maltose, sucrose and lactose. They have two or more monosaccharides bound together, and any of the polysaccharides includes glucose as a monosaccharide as a binding unit. Amylose and amylopectin are components that are contained in starch, and starch is a mixture of amylose and amylopectin. In the case where glucoamylase is used as a degrading enzyme for a polysaccharide and glucose dehydrogenase is used as an oxidase that degrades a monosaccharide and when a polysaccharide capable of being degraded to glucose by glucoamylase, power generation can be performed using the polysaccharide as a fuel. Specific examples of the polysaccharide include starch, amylose, amylopectin, glycogen and maltose. Glucoamylase is a degrading enzyme which hydrolyzes α-glucan such as starch to generate glucose, and glucose dehydrogenase is an oxidase which oxidizes β-D-glucose to D-glucono-δ-lactone. Preferably, a degrading enzyme to degrade a polysaccharide is also immobilized on the negative electrode, and a polysaccharide that ultimately serves as a fuel is also immobilized on the negative electrode.

When starch is used as a fuel, a gel-like solidified fuel formed by gelatinizing starch can also be used. In this case, preferably a method can be employed in which gelatinized starch is brought into contact with a negative electrode with an enzyme or the like immobilized thereon, or is immobilized on a negative electrode together with an enzyme or the like. When such an electrode is used, the concentration of starch on the negative electrode surface can be kept high, so that degradation reaction by an enzyme becomes faster, as compared to a case where starch dissolved in a solution is used. Accordingly, the output of the biofuel cell is enhanced, a fuel supply system can be simplified because handling of a fuel is easy as compared to the case of a solution, and moreover necessity to prohibit the biofuel cell from being turned over is eliminated, so that there is an enormous advantage when the biofuel cell is used for, for example, mobile devices.

When methanol is used as a fuel, methanol is degraded to CO₂ by passing through three stages of oxidation process by alcohol dehydrogenase (ADH) which oxidizes methanol to formaldehyde by acting as a catalyst on methanol, formaldehyde dehydrogenase (FalDH) which oxidizes formaldehyde to formic acid by acting on formaldehyde and formic acid dehydrogenase (FateDH) which oxidizes formic acid to CO₂ by acting on formic acid. That is, three NADHs are generated per molecule of methanol, and total six electrons are generated.

When ethanol is used as a fuel, ethanol is degraded to acetic acid by passing through two stages of oxidation process by alcohol dehydrogenase (ADH) which oxidizes ethanol to acetaldehyde by acting on ethanol and aldehyde dehydrogenase (AlDH) which oxidizes acetaldehyde to acetic acid by acting on acetaldehyde. That is, total four electrons are generated by two stages of oxidation reaction per molecule of ethanol.

A method of degrading ethanol to CO₂ can be employed as in the case of methanol. In this case, acetaldehyde dehydrogenase (AalDH) is made to act on acetaldehyde to form acetyl CoA, which is then delivered to the TCA cycle. Electrons are further generated in the TCA cycle.

These fuels are typically used in the form of a fuel solution formed by dissolving the fuel in a previously well-known buffer solution such as a phosphate buffer solution or a tris buffer solution.

As the electron mediator, basically any compound may be used, but preferably a compound having a quinone skeleton, particularly a compound having a naphthoquinone skeleton is used. As the compound having a naphthoquinone skeleton, various kinds of naphthoquinone derivatives can be used. Specific examples of the naphthoquinone derivative 2-amino-1,4-naphthoquinone (ANQ), 2-amino-3-methyl-1, 4-naphthoquinone (AMNQ), 2-methyl-1,4-naphthoquinone (VK3) and 2-amino-3-carboxy-1,4-naphthoquinone (ACNQ). Besides the compound having a naphthoquinone skeleton, for example anthraquinone or a derivative thereof can also be used as the compound having a quinone skeleton. In the electron mediator, one or two or more other compounds acting as an electron mediator may be included as necessary in addition to the compound having a quinone skeleton. Preferably acetone is used as a solvent to be used when the compound having a quinone skeleton, particularly the compound having a naphthoquinone compound is immobilized on the negative electrode. By using acetone as a solvent as described above, solubility of the compound having a quinone skeleton can be enhanced, so that the compound having a quinone skeleton can be efficiently immobilized on the negative electrode. In the solvent, one or two or more solvents other than acetone may be included as necessary.

On the other hand, when an enzyme is immobilized on the positive electrode, the enzyme typically includes an oxygen reductase. As the oxygen reductase, for example, bilirubin oxidase, laccase, ascorbate oxidase or the like can be used. In this case, preferably the electron mediator is immobilized on the positive electrode in addition to the enzyme. As the electron mediator, for example, potassium cyanohexaferrate, potassium octacyanotungstate or the like is used. Preferably the electron mediator is immobilized in a sufficiently high concentration of, for example, 0.64×10⁻⁶ mol/mm² or more in terms of an average value.

As the proton conductor, various proton conductors can be used, a selection is made as necessary, and specific examples include those including cellophane, a perfluorocarbon sulfonic acid (PFS)-based resin membrane, a copolymerization membrane of a trifluorostyrene derivative, a polybenzimidazole membrane impregnated with phosphoric acid, an aromatic polyether ketone sulfonic acid membrane, PSSA-PVA polystyrene sulfonic acid-polyvinyl alcohol copolymer (PSSA-PVA), polystyrene sulfonic acid-ethylene-vinyl alcohol copolymer (PSSA-EVOH), and an ion-exchange resin having a fluorine-containing carbon sulfonic acid group (Nafion (trade name, DuPont in USA) or the like).

When an electrolyte containing a buffer solution (buffer substance) is used as the proton conductor, it is desirable to ensure that a sufficient buffering capacity can be obtained during high-output operations, and a capability intrinsically possessed by oxygen can be sufficiently exhibited. For this, the concentration of a buffer substance contained in the electrolyte is advantageously 0.2 M or more and 2.5 M or less, preferably 0.2 M or more and 2 M or less, more preferably 0.4 M or more and 2 M or less, further preferably 0.8 M or more and 1.2 M or less. As the buffer substance, generally any buffer substance may be used as long as it has a pKₐ of 6 or more and 9 or less, and specific examples include a dihydrogen phosphate ion (H₂PO₄⁻), 2-amino-2-hydroxymethyl-1,3-propanediol (abbreviated name: Tris), 2-(N-morpholino) ethanesulfonic acid (MES), cacodylic acid, carbonic acid (H₂CO₃), a hydrogen citrate ion, N-(2-acetamide)iminodiacetic acid (ADA), piperazine-N,N′-bis(2-ethanesulfonic acid) (PIPES), N-(2-acetamide)-2-aminoethanesulfonic acid (ACES), 3-(N-morpholino)propanesulfonic acid (MOPS), N-2-hydroxyethylpiperazine-N′-2-ethanesulfonic acid (HEPES), N-2-hydroxyethylpiperazine-N′-3-propanesulfonic acid (HEPPS), N-[tris(hydroxymthyl)methyl)glycine (abbreviated name: Tricine), glycylglycine and N,N-bis(2-hydroxyethyl)glycine (abbreviated name: Bicine). Examples of the substance that generates a dihydrogen phosphate ion (H₂PO₄⁻) include sodium dihydrogen-phosphate (NaH PO₄) and potassium dihydrogen-phosphate (KH₂PO₄). As the buffer substance, a compound containing an imidazole ring is preferable. Specific examples of the compound containing an imidazole ring include imidazole, triazole, pyridine derivatives, bipyridine derivatives, imidazole derivatives (histidine, 1-methylimidazole, 2-methylimidazole, 4-methylimidazole, 2-ethylimidazole, imidazole-2-ethyl carbonate, imidazole-2-carboxyaldehyde, imidazole-4-carboxylic acid, imidazole-4,5-dicarboxylix acid, imidazole-1-yl-acetic acid, 2-acetylbenzimidazole, 1-acetylimidazole, N-acetylimidazole, 2-aminobenzimidazole, N-(3-aminopropyl)imidazole, 5-amino-2-(trifluoromethyl)banzimidazole, 4-azabenzimidazole, 4-aza-2-mercaptobenzimidazole, banzimidazole, 1-benzylimidazole and 1-butylimidazole. In addition to these buffer substances, at least one acid selected from the group consisting of, for example, hydrochloric acid (HCl), acetic acid (CH₃COOH), phosphoric acid (H₃PO₄) and sulfuric acid (H₂SO₄) may be added as a neutralizer as necessary. By doing so, activity of the enzyme can be kept higher. The pH of the electrolyte containing a buffer substance is preferably around 7, but generally may be in a range of 1 to 14.

This biofuel cell can be used for all articles that need electric power, may have any size, and can be used for, for example, electronic devices, mobile bodies (automobiles, two-wheeled vehicles, aircrafts, rockets, spacecrafts and watercrafts or the like), power units, construction machines, machine tools, power generation systems, cogeneration systems and so on, and an output, a size, a shape, a type of fuel and the like of the biofuel cell are determined according to a use or the like.

The electronic device may be basically any electronic device, and include a portable type and a stationary type, and specific examples include cellular phones, mobile devices (mobile information terminal devices (PDA) or the like), robots, personal computers (including both a desktop type and a note type), game devices, camera-integrated VTRs (video tape recorders), vehicle-mounted equipment, home electric appliances and industrial products.

The present disclosure also relates to an enzyme immobilization electrode with an enzyme immobilized on an electrode including a mixture containing carbon particles and a water-insoluble hydrophilic binder.

Further, according to the present disclosure, there is provided a method for production of an enzyme immobilization electrode, the method including the steps of:
forming an electrode from a mixture containing carbon particles and a water-insoluble hydrophilic binder; and immobilizing an enzyme on the electrode.

When the enzyme immobilization electrode is used for the biofuel cell, the enzyme immobilization electrode is formed integrally on a separator as necessary. Similarly, in the method for production of the enzyme immobilization electrode, a paste containing carbon particles and a water-insoluble hydrophilic binder is applied onto a separator, and the paste is then solidified, whereby an electrode including a mixture containing carbon particles and a water-insoluble hydrophilic binder is formed integrally with the separator.

The present disclosure also relates to an electrode for production of an enzyme immobilization electrode, which includes a mixture containing carbon particles and a water-insoluble hydrophilic binder.

The present disclosure also relates to a method for production of an electrode for production of an enzyme immobilization electrode, wherein a paste containing carbon particles and a water-insoluble hydrophilic binder is applied onto a substrate, and the paste is then solidified to produce an electrode for production of an enzyme immobilization electrode.

By immobilizing an enzyme on the electrode for production of an enzyme immobilization electrode, an enzyme immobilization electrode can be obtained.

The present disclosure also relates to an enzyme reaction using device including an enzyme immobilization electrode which includes a mixture containing carbon particles and water-insoluble hydrophilic binder and on which an enzyme is immobilized.

The enzyme reaction using device is, for example, a biofuel cell, a biosensor or a bioreactor.

For the above-described enzyme immobilization electrode, method for production of an enzyme immobilization electrode, electrode for production of an enzyme immobilization electrode, method for production of an electrode for production of an enzyme immobilization electrode and enzyme reaction using device, the matters explained in connection with the above-described biofuel cell and method for production of a biofuel cell hold true as long as their natures are contradicted.

As described above, in the present disclosure, the electrode on which an enzyme is immobilized includes a mixture containing carbon particles and a water-insoluble hydrophilic binder, so that an enzyme solution easily penetrates into the electrode at the time of immobilizing the enzyme on the electrode, and deactivation of the enzyme can be prevented.

### Effects of the Invention

According to the present disclosure, an enzyme immobilization electrode capable of easily immobilizing an enzyme while retaining activity of the enzyme can be obtained. By using the enzyme immobilization electrode for at least one of a positive electrode and a negative electrode of a biofuel cell, an excellent biofuel cell can be achieved. By using the excellent biofuel cell, a high-performance electronic device or the like can be achieved. By using the enzyme immobilization electrode for an enzyme reaction using device, an excellent enzyme reaction using device can be achieved.

### BRIEF DESCRIPTION OF DRAWINGS

FIGS. 1A and 1B are diagrams illustrating an electrode for production of an enzyme immobilization electrode according to a first embodiment.

FIGS. 2A, 2B and 2C are sectional views for explaining a method for production of an electrode for production of the enzyme immobilization electrode according to the first embodiment.

FIGS. 3A and 3B are sectional views for explaining a method for production of electrodes for production of an enzyme immobilization electrode according to Examples 1 to 8.

FIGS. 4A, 4B, 4C, 4D and 4E are diagrams illustrating a contact angle of an enzyme solution to electrodes for production of an enzyme immobilization electrode in Examples 3, 5 and 7 and Comparative Examples 1 and 2.

FIG. 5 is a diagram illustrating results of cyclic voltammetry measurement performed using the electrodes for production of an enzyme immobilization electrode in Example 1.

FIG. 6 is a diagram in which a peak current density obtained from the result illustrated in FIG. 5 is plotted to the ½th power of a potential sweep rate.

FIG. 7 is a diagram illustrating results of cyclic voltammetry measurement performed using the electrodes for production of an enzyme immobilization electrode in Example 8.

FIG. 8 is a diagram illustrating results of cyclic voltammetry measurement performed using the electrodes for production of an enzyme immobilization electrode in Example 8.

FIG. 9 is a drawing substituting photograph illustrating results of evaluating solubility in water and hydrophilicity of various kinds of binders.

FIG. 10 is a diagram illustrating results of cyclic voltammetry measurement performed using an enzyme immobilization electrode of Example 9.

FIG. 11 is a diagram illustrating a biofuel cell according to a third embodiment.

FIG. 12 is a diagram schematically illustrating details of a configuration of a negative electrode of the biofuel cell according to the third embodiment, and one example of an enzyme group and a coenzyme immobilized on the negative electrode and a delivery reaction of an electron by the enzyme group and coenzyme.

FIG. 13 is a schematic view illustrating a specific configuration example of the biofuel cell according to the third embodiment.

FIG. 14 is a diagram illustrating results of measuring a relative output after elapse of one hour after biofuel cells using electrodes for production of an enzyme immobilization electrode of Examples 5 and 7 and Comparative Examples 1 and 2 for the positive electrode and the negative electrode.

### MODE FOR CARRYING OUT THE INVENTION

Modes for carrying out the invention (hereinafter, referred to as “embodiments”) will be explained below.

Explanations are presented in the following order: 1. First embodiment (electrode for production of enzyme immobilization electrode and method for production thereof); 2. Second embodiment (enzyme immobilization electrode and method for production thereof); and 3. Third embodiment (biofuel cell).

### 1. First Embodiment

### Electrode for Production of Enzyme Immobilization Electrode

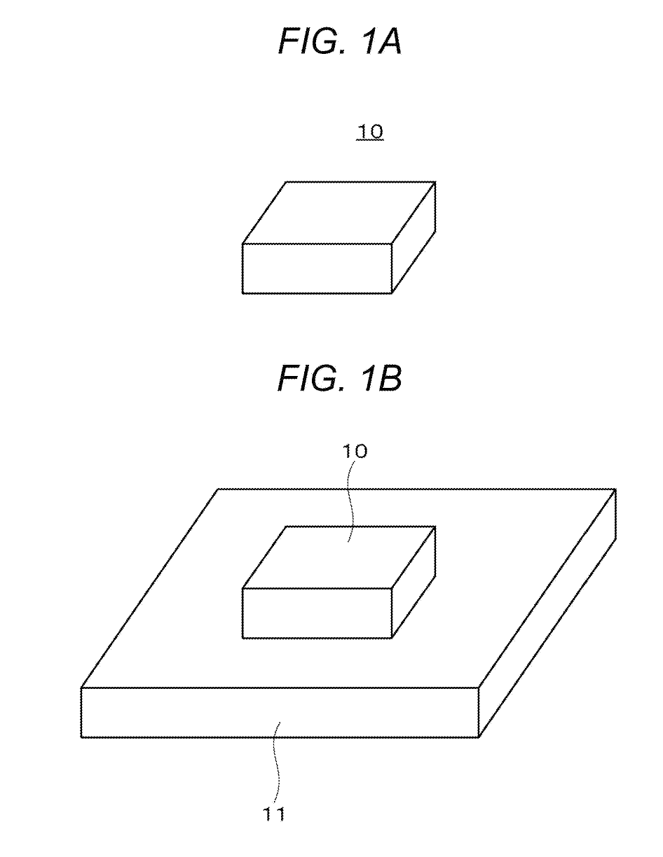

FIG. 1A illustrates an electrode for production of an enzyme immobilization electrode 10 according to the first embodiment.

As illustrated in FIG. 1A, the electrode for production of an enzyme immobilization electrode 10 includes a mixture containing carbon particles and a water-insoluble hydrophilic binder. The mixture is typically contains at least carbon particles and a water-insoluble hydrophilic binder as major components, and preferably consist of carbon particles and a water-insoluble hydrophilic binder. The ratio of the mass of the water-insoluble hydrophilic binder to the mass of carbon particles in this mixture is, for example, 0.01 or more and 1 or less.

The carbon particle is, for example, carbon black (ketjen black or the like), bio-carbon, vapor phase process carbon fiber or the like. The water-insoluble hydrophilic binder is, for example, ethyl cellulose, polyvinyl butyral, an acrylic resin, an epoxy resin or the like.

The electrode for production of an enzyme immobilization electrode 10 may be used alone, but as illustrated in FIG. 1B, the electrode for production of an enzyme immobilization electrode 10, which is formed on a substrate 11, may be used. In this case, the mechanical strength of the electrode for production of an enzyme immobilization electrode 10 can be improved because the electrode for production of an enzyme immobilization electrode 10 is supported by the substrate 11.

### [Method for Production of Electrode for Production of Enzyme Immobilization Electrode]

The electrode for production of an enzyme immobilization electrode 10 can be produced, for example, in the following manner.

First, carbon particles and a water-insoluble hydrophilic binder are mixed. The ratio of the mass of the water-insoluble hydrophilic binder to the mass of carbon particles in the mixture is, for example, 0.01 or more and 1 or less.

Next, a solvent is added to the mixture, and the mixture is stirred to prepare a paste. As the solvent, one appropriately selected from organic solvents such as methyl isobutyl ketone (MIBK), terpineol, 2-propanol, butyl carbitol acetate, butyl carbitol and methyl ethyl ketone is used. A ratio of the mixture to the solvent is selected as necessary.

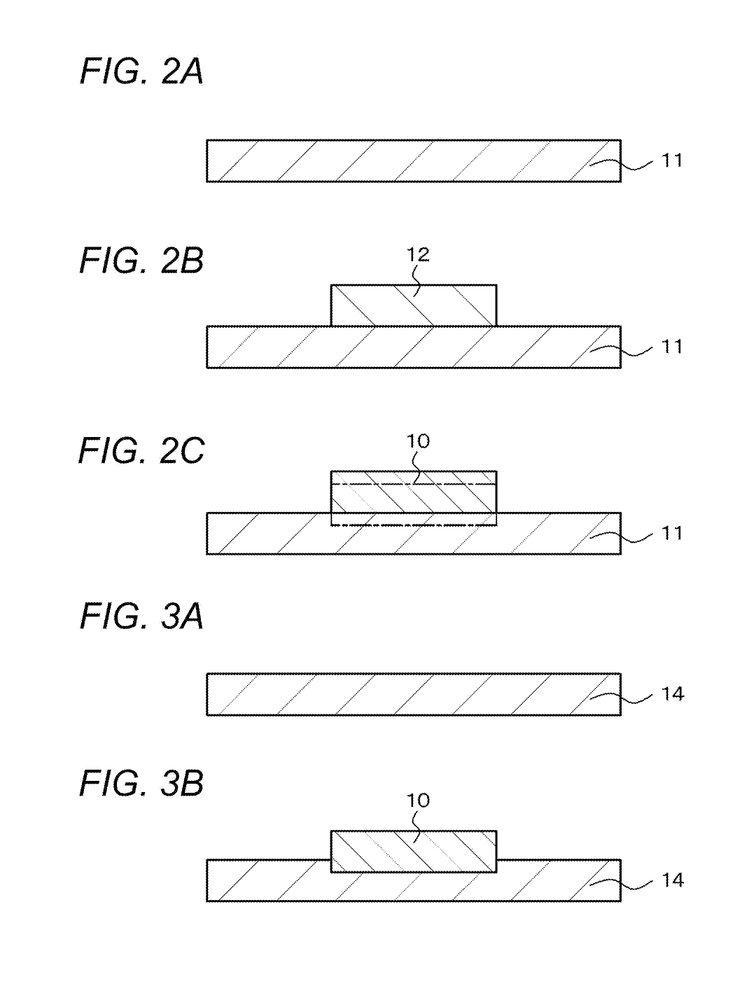

Next, as illustrated in FIG. 2A, the substrate 11 is provided. Next, as illustrated in FIG. 2B, a paste 12 prepared as described above is applied or printed onto one principal surface of the substrate 11. As the substrate 11, preferably a nonwoven fabric can be used. As a material of the nonwoven fabric, various kinds of organic polymer compounds such as polyolefin, polyester, cellulose and polyacrylamide can be used, but the material is not limited thereto. The method for applying or printing the paste 12 is not particularly limited, a previously well-known method can be used. Specifically, for example, a dipping method, a spraying method, a wire bar method, a spin coating method, a roller coating method, a blade coating method, a gravure coating method or the like can be used as the application method. As the printing method, a relief printing method, an offset printing method, a gravure printing method, an intaglio printing method, a rubber plate printing method, a screen printing method or the like can be used.

Next, the substrate 11 to which the paste 12 is applied in this way is heated, or held at room temperature to be dried to remove a solvent in the paste 12, so that the paste 12 is solidified. In this way, the electrode for production of an enzyme immobilization electrode 10 including carbon particles and a water-insoluble hydrophilic binder is obtained on the substrate 11 as illustrated in FIG. 2C. Thereafter, both the surfaces of the substrate 11 provided with the electrode for production of an enzyme immobilization electrode 10 are cleaned by an ozone treatment as necessary.

Depending on a material of the substrate 11, the paste 12 may penetrate into the substrate 11. In this case, the electrode for production of an enzyme immobilization electrode 10 is formed with its part buried in the substrate 11 as illustrated by a one dot chain line in FIG. 2C.

### Example 1

An electrode for production of an enzyme immobilization electrode 10 was formed using ketjen black as carbon particles and ethyl cellulose as a water-insoluble hydrophilic binder in the following manner.

1 g of ketjen black and 0.4 g of ethyl cellulose were mixed, 7.5 g of terpineol was added to the mixture, and the mixture was then stirred twice each for 10 minutes to prepare a paste 12.

As illustrated in FIG. 3A, a nonwoven fabric 14 is used as a substrate 11. As illustrated in FIG. 3B, the paste 12 was applied onto the nonwoven fabric 14 in a thickness of 50 μm using a coater, and heated on a hot plate at 75° C. for 2 hours to be dried to remove terpineol.

In this way, the electrode for production of an enzyme immobilization electrode 10, which includes ketjen black and ethyl cellulose, was formed on the nonwoven fabric 14. At this time, the electrode for production of an enzyme immobilization electrode 10 was formed with its lower part buried in the nonwoven fabric 14.

Thereafter, both the surfaces of the nonwoven fabric 14 provided with the electrode for production of an enzyme immobilization electrode 10, i.e. the upper surface of the electrode for production of an enzyme immobilization electrode 10 and the back surface of the nonwoven fabric 14 were subjected to an ozone treatment for 20 minutes, thereby performing cleaning.

### Example 2

An electrode for production of an enzyme immobilization electrode 10 was formed using ketjen black and bio-carbon as carbon particles and ethyl cellulose as a water-insoluble hydrophilic binder in the following manner.

0.5 g of ketjen black, 1 g of bio-carbon and 0.4 g of ethyl cellulose were mixed, 7.5 g of terpineol was added to the mixture, and the mixture was then stirred twice each for 10 minutes to prepare a paste 12.

Thereafter, a treatment similar to that in Example 1 was performed to form the electrode for production of an enzyme immobilization electrode 10, which includes ketjen black, bio-carbon and ethyl cellulose, on a nonwoven fabric 14.

### Example 3

An electrode for production of an enzyme immobilization electrode 10 was formed using ketjen black and VGCF (registered trademark) as carbon particles and ethyl cellulose as a water-insoluble hydrophilic binder in the following manner.

0.5 g of ketjen black, 0.5 g of VGCF and 0.4 g of ethyl cellulose were mixed, 7.5 g of terpineol was added to the mixture, and the mixture was then stirred twice each for 10 minutes to prepare a paste 12.

Thereafter, a treatment similar to that in Example 1 was performed to form the electrode for production of an enzyme immobilization electrode 10, which includes ketjen black, VGCF and ethyl cellulose, on a nonwoven fabric 14.

### Example 4

An electrode for production of an enzyme immobilization electrode 10 was formed using VGCF (registered trademark) as carbon particles and ethyl cellulose as a water-insoluble hydrophilic binder in the following manner.

1 g of VGCF and 0.4 g of ethyl cellulose were mixed, 7.5 g of terpineol was added to the mixture, and the mixture was then stirred twice each for 10 minutes to prepare a paste 12.

Thereafter, a treatment similar to that in Example 1 was performed to form the electrode for production of an enzyme immobilization electrode 10, which includes VGCF and ethyl cellulose, on a nonwoven fabric 14.

### Example 5

An electrode for production of an enzyme immobilization electrode 10 was formed using ketjen black and VGCF (registered trademark) as carbon particles and ethyl cellulose as a water-insoluble hydrophilic binder in the following manner.

0.5 g of ketjen black, 0.5 g of VGCF and 0.6 g of ethyl cellulose were mixed, 8 ml of methyl isobutyl ketone was added to the mixture, and the mixture was then stirred twice each for 10 minutes to prepare a paste 12.

The paste 12 was applied to a nonwoven fabric 14 in a thickness of 50 μm using a coater, and then dried at room temperature to remove methyl isobutyl ketone.

Thereafter, a treatment similar to that in Example 1 was performed to form the electrode for production of an enzyme immobilization electrode 10, which includes ketjen black, VGCF and ethyl cellulose, on the nonwoven fabric 14.

### Example 6

An electrode for production of an enzyme immobilization electrode 10 was formed using ketjen black and VGCF (registered trademark) as carbon particles and ethyl cellulose as a water-insoluble hydrophilic binder in the following manner.

0.5 g of ketjen black, 0.5 g of VGCF and 0.6 g of ethyl cellulose were mixed, 8 ml of 2-propanol was added to the mixture, and the mixture was then stirred twice each for 10 minutes to prepare a paste 12.

The paste 12 was applied to a nonwoven fabric 14 in a thickness of 50 μm using a coater, and then dried at room temperature to remove 2-propanol.

Thereafter, a treatment similar to that in Example 1 was performed to form the electrode for production of an enzyme immobilization electrode 10, which includes ketjen black, VGCF and ethyl cellulose, on the nonwoven fabric 14.

### Example 7

An electrode for production of an enzyme immobilization electrode 10 was formed using ketjen black and VGCF (registered trademark) as carbon particles and polyvinyl butyral as a water-insoluble hydrophilic binder in the following manner.

0.5 g of ketjen black, 0.5 g of VGCF and 0.2 g of polyvinyl butyral (polymerization degree: 1000) were mixed, 8 ml of methyl isobutyl ketone was added to the mixture, and the mixture was then stirred twice each for 10 minutes to prepare a paste 12.

The paste 12 was applied to a nonwoven fabric 14 in a thickness of 50 μm using a coater, and then dried at room temperature to remove methyl isobutyl ketone.

Thereafter, a treatment similar to that in Example 1 was performed to form the electrode for production of an enzyme immobilization electrode 10, which includes ketjen black, VGCF and polyvinyl butyral, on the nonwoven fabric 14.

### Example 8

An electrode for production of an enzyme immobilization electrode 10 was formed using bio-carbon as carbon particles and ethyl cellulose as a water-insoluble hydrophilic binder in the following manner.

1 g of bio-carbon and 0.4 g of ethyl cellulose were mixed, 8 ml of terpineol was added to the mixture, and the mixture was then stirred twice each for 10 minutes to prepare a paste 12.

Thereafter, a treatment similar to that in Example 1 was performed to form the electrode for production of an enzyme immobilization electrode 10, which includes bio-carbon and ethyl cellulose, on a nonwoven fabric 14.

### Comparative Example 1

An electrode for production of an enzyme immobilization electrode was formed using ketjen black and VGCF (registered trademark) as carbon particles and carboxymethyl cellulose as a binder in the following manner.

0.5 g of ketjen black, 0.5 g of VGCF and 0.2 g of carboxymethyl cellulose were mixed, 8 ml of water was added to the mixture, and the mixture was then stirred twice each for 10 minutes to prepare a paste.

The paste was applied to a nonwoven fabric 14 in a thickness of 50 μm using a coater, and then dried at room temperature to remove water.

Thereafter, a treatment similar to that in Example 1 was performed to form the electrode for production of an enzyme immobilization electrode, which includes ketjen black, VGCF and carboxymethyl cellulose, on the nonwoven fabric 14.

### Comparative Example 2

An electrode for production of an enzyme immobilization electrode was formed using ketjen black and VGCF (registered trademark) as carbon particles and polyvinylidene fluoride (PVDF) as a binder in the following manner.

0.5 g of ketjen black, 0.5 g of VGCF and 0.1 g of polyvinylidene fluoride (PVDF) were mixed, 8 ml of N-methyl pyrrolidone (NMP) was added to the mixture, and the mixture was then stirred twice each for 10 minutes to prepare a paste.

The paste was applied to a nonwoven fabric 14 in a thickness of 50 μm using a coater, and then fired at 120° C.

Thereafter, a treatment similar to that in Example 1 was performed to form the electrode for production of an enzyme immobilization electrode, which includes ketjen black, VGCF and polyvinylidene fluoride (PVDF), on the nonwoven fabric 14.

### <Results of Measuring Contact Angle of Enzyme Solution>

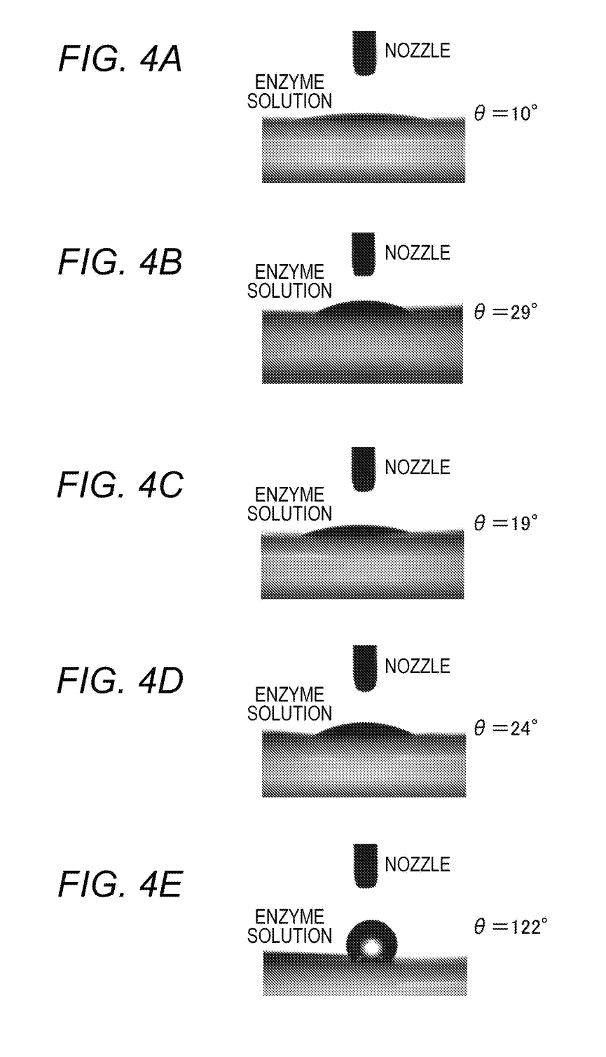

Results of measuring a contact angle of an enzyme solution to the electrodes for production of an enzyme immobilization electrode 10 in Examples 3, 5 and 7 and the electrodes for production of an enzyme immobilization electrode in Comparative Examples 1 and 2 are illustrated in FIGS. 4A to 4E, respectively. A contact angle θ to the electrode for production of an enzyme immobilization electrode 10 in Example 3 illustrated in FIG. 4A is 10°, a contact angle θ to the electrode for production of an enzyme immobilization electrode 10 in Example 5 illustrated in FIG. 4B is 29°, and a contact angle θ to the electrode for production of an enzyme immobilization electrode 10 in Example 7 illustrated in FIG. 4C is 19°, showing that the contact angles in these Examples are small. As a result, the enzyme solution easily penetrated into the electrodes for production of an enzyme immobilization electrode 10 in Examples 3, 5 and 7. On the other hand, a contact angle θ to the electrode for production of an enzyme immobilization electrode in Comparative Example 1 illustrated in FIG. 4D was 24°, and thus the enzyme solution easily penetrated, but peeling of carbon particles was found after several minutes, and it was confirmed that the electrode for production of an enzyme immobilization electrode in Comparative Example 1 did not function as an electrode. A contact angle to the electrode for production of an enzyme immobilization electrode in Comparative Example 2 illustrated in FIG. 4E was as large as 122°. As a result, the enzyme solution did not penetrate into the electrodes for production of an enzyme immobilization electrode in Comparative Examples 1 and 2, but was dried on the electrode surface.

### <Results of Cyclic Voltammetry Evaluation>

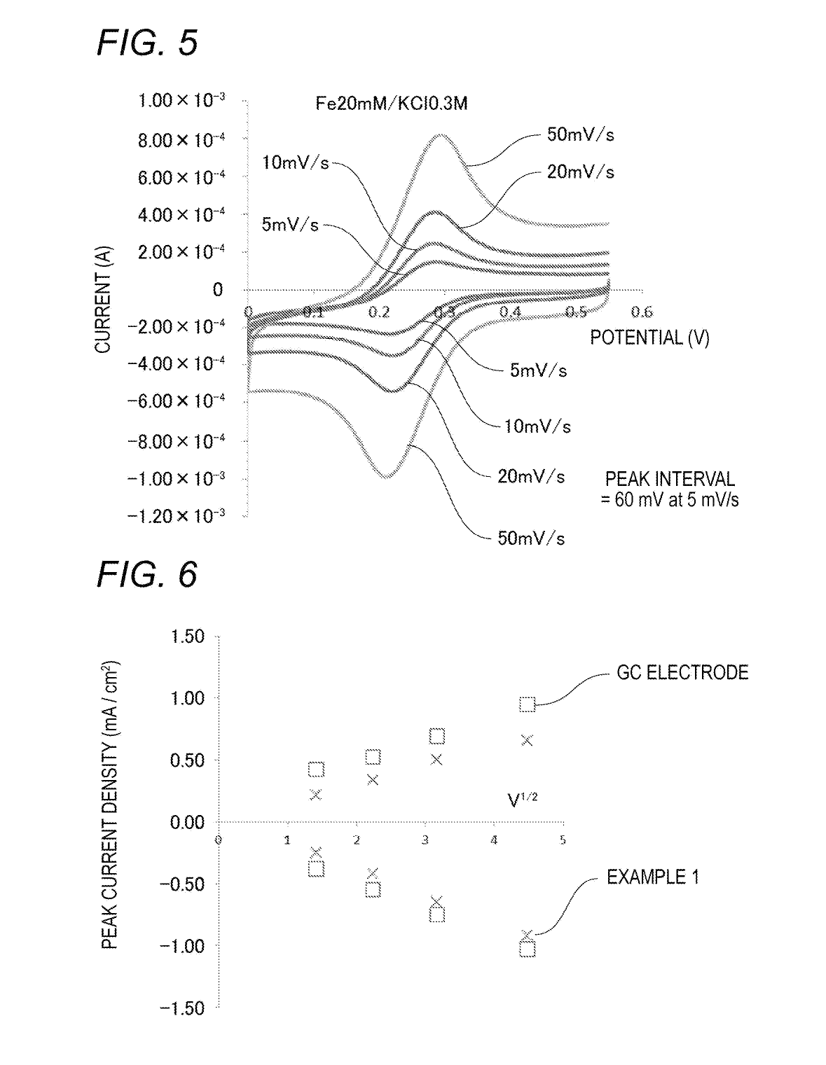

Electrode performance was evaluated using the electrode for production of an enzyme immobilization electrode 10 in Example 1. For this purpose, cyclic voltammetry evaluation was performed using hexacyanoferric acid ions. The results are illustrated in FIG. 5. As apparent from FIG. 5, the electrode for production of an enzyme immobilization electrode 10 in Example 1 where ethyl cellulose was used as a binder showed a very good electrochemical response. FIG. 6 is a graph in which a ½ power of a potential sweep rate V (V^{1/2}) is plotted on the horizontal axis and a peak current value in a cyclic voltammogram is plotted on the vertical axis. In FIG. 6, similar data where a commercially available smooth glassy carbon (GC) electrode is used is plotted for comparison. From FIG. 6, it is apparent that the electrode for production of an enzyme immobilization electrode 10 in Example 1 shows an electrochemically reversible response because a peak current almost identical to that in a glassy carbon electrode that is generally used electrochemical evaluation, and the peak current is proportional to V^{1/2}.

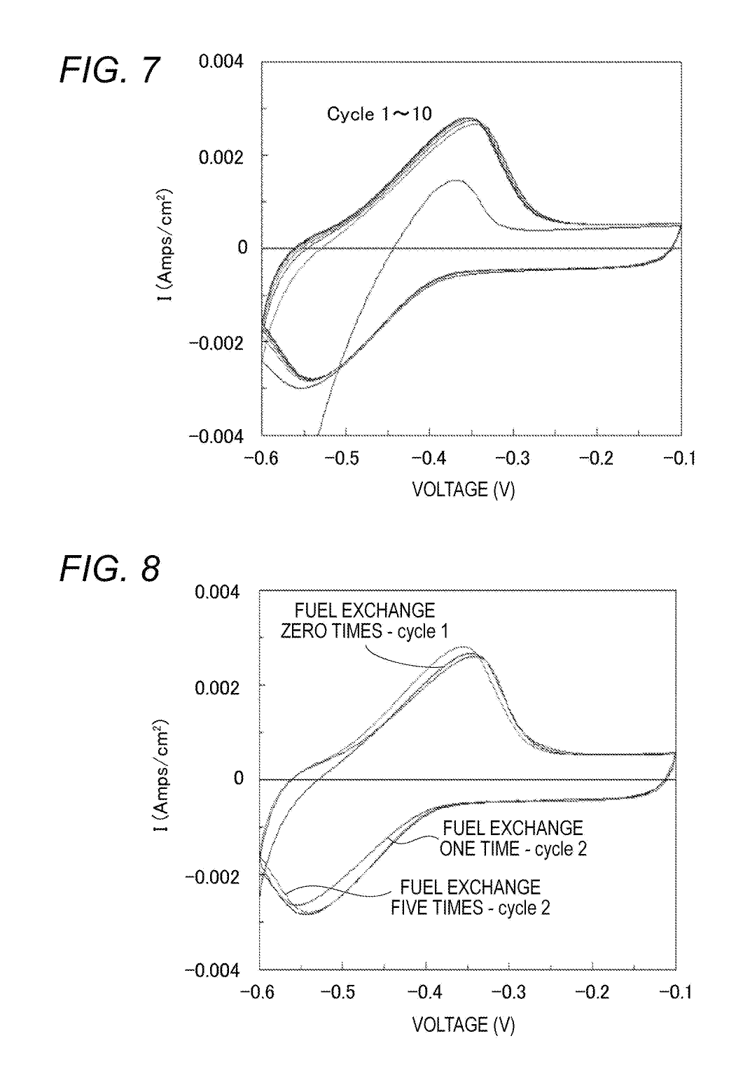

FIG. 7 illustrates results of performing cyclic voltammetry evaluation using the electrode for production of an enzyme immobilization electrode 10 in Example 8, which includes bio-carbon and ethyl cellulose, and using a fuel solution obtained by dissolving AQ2S (anthraquinone-2-sulfonic acid), which is a quinone derivative, in a 10 mM phosphate buffer solution (pH 7) as an electron mediator. From FIG. 7, electrochemical characteristics are retained even when 10 cycles of potential sweep are performed. FIG. 8 illustrates results of cyclic voltammetry measurement when fuel exchange is performed, and it is apparent that electrochemical characteristics are retained even when fuel exchange is performed. These results show an advantage of using ethyl cellulose as a binder when bio-carbon is used as carbon particles. That is, bio-carbon has an ability to adsorb low-molecular-weight molecules, but bio-carbon was required to be applied to a carbon fiber electrode. This is intended to efficiently collect currents from bio-carbon that is in the form of a powder, or to suppress dispersion of bio-carbon into a solution. On the other hand, it is apparent from the results in FIGS. 7 and 8 that by using ethyl cellulose as a binder of bio-carbon the electrode for production of an enzyme immobilization electrode 10 can be formed while the ability of bio-carbon to adsorb low-molecular-weight molecules is retained without using a carbon fiber electrode. Consequently, the electrode for production of an enzyme immobilization electrode 10 can be thinly formed because a carbon fiber electrode is not required, and the problem of dispersion of bio-carbon into a solution can be solved.

### <Method for Defining Water-Insoluble Hydrophilic Binder>

A method for defining a water-insoluble hydrophilic binder to be used for production of the electrode for production of an enzyme immobilization electrode 10 will now be explained.

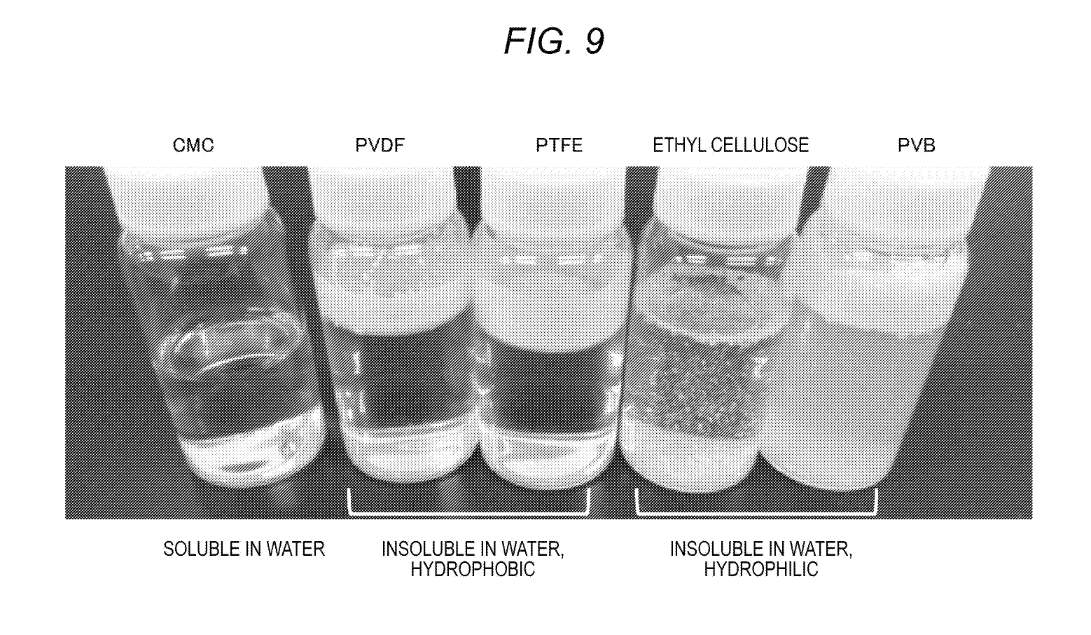

Water is added to a binder powder (not including a surfactant or the like) at room temperature, and the mixture is stirred for 10 minutes, subsequently defoamed for 1 minute, then temporarily left standing, further stirred for 10 minutes, subsequently defoamed for 1 minute, and then left standing for about 10 minutes. After this operation is carried out, a state of water to which the binder powder is added is observed to assess solubility in water and hydrophilicity. Results of conducting experiments using five binders are illustrated in FIG. 9. From FIG. 9, polyvinyl fluoride (PVDF) and polytetrafluoroethylene (PTFE) are insoluble in water, and carboxymethyl cellulose (CMC) is soluble in water. Although not illustrated, polyacrylic acid is soluble in water like carboxymethyl cellulose. A water-soluble binder is not suitable as a binder because the carbon powder cannot be kept in the shape of an electrode. On the other hand, ethyl cellulose and polyvinyl butyral are both insoluble in water and hydrophilic, and are suspended or precipitated in water. The structural formulae of these binders are as follows.

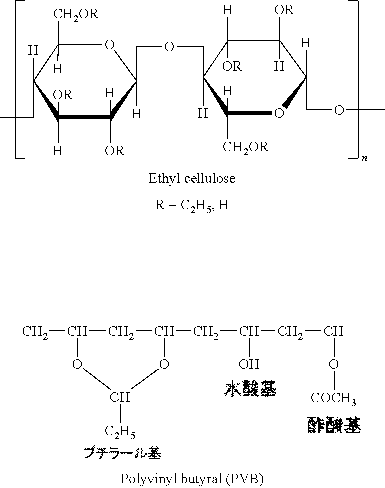

butyral group
hydroxyl group
acetic acid group

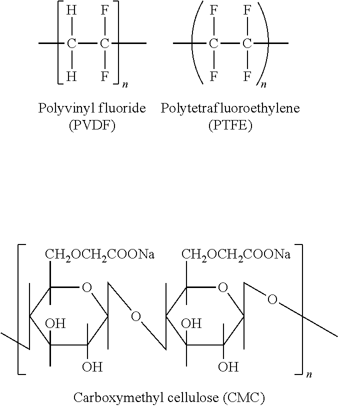

As described above, according to the first embodiment, the electrode for production of an enzyme immobilization electrode 10 includes carbon particles and a water-insoluble hydrophilic binder, so that an enzyme solution easily penetrates, an enzyme can be therefore easily immobilized, and moreover activity of the enzyme can be retained.

### 2. Second Embodiment

### Enzyme Immobilization Electrode

An enzyme immobilization electrode according to the second embodiment has one or two or more enzymes immobilized on the electrode for production of an enzyme immobilization electrode 10 according to the first embodiment. These enzymes are appropriately selected according to a use of the enzyme immobilization electrode.

### [Method for Production of Enzyme Immobilization Electrode]

The enzyme immobilization electrode can be produced by applying or adding an enzyme solution dropwise to the electrode for production of an enzyme immobilization electrode 10 according to the first embodiment, or immersing the electrode for production of an enzyme immobilization electrode 10 in an enzyme solution. At this time, when a water-repellent separator, for example a nonwoven fabric made water-repellent by a silicon-based water repellent, is used as a substrate 14, a carbon coating can be applied to a predetermined region of the surface of the separator to selectively apply an enzyme solution to only the site where the carbon coating is applied. By using an enzyme immobilization electrode for a positive electrode of a negative electrode of a biofuel cell, spreading of a fuel to areas other than a power supply unit can be inhibited, and loss of the fuel and contamination of a housing at the time of addition or injection of the fuel can be prevented.

### Example 9

An enzyme solution obtained by dissolving bilirubin oxidase (BOD), an oxygen reductase, in a 10 mM phosphate buffer solution (pH 7) was added dropwise to the electrode for production of an enzyme immobilization electrode 10 in Example 5, which includes ketjen black, VGCF and ethyl cellulose, thereby immobilizing bilirubin oxidase to form a positive electrode of a biofuel cell.

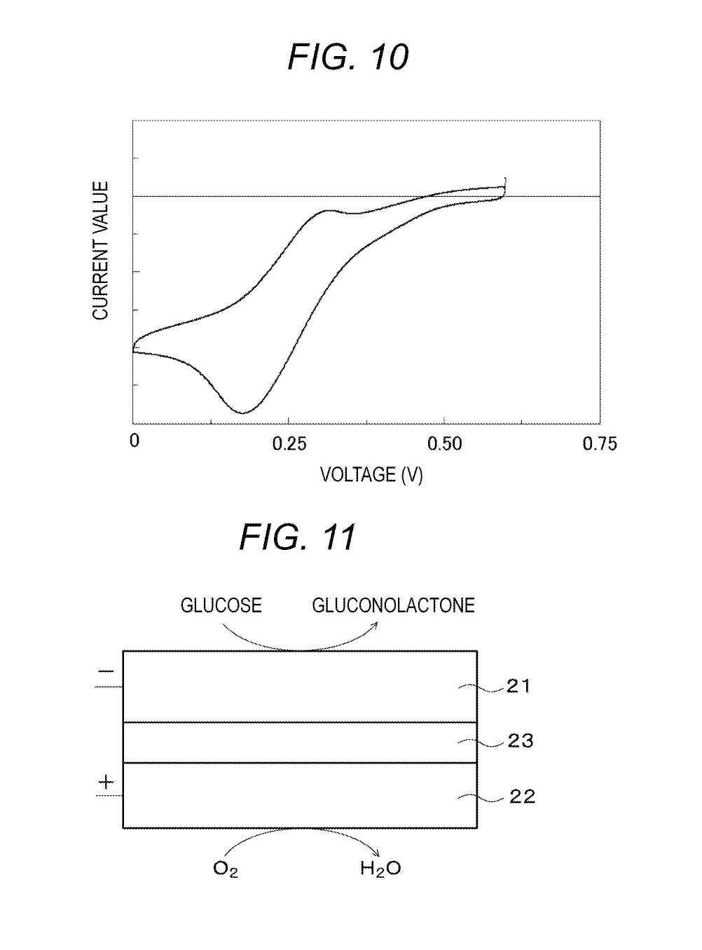

Results of performing cyclic voltammetry measurement using the positive electrode are illustrated in FIG. 10. As illustrated in FIG. 10, good results are obtained.

According to the second embodiment, an enzyme immobilization electrode capable of easily immobilizing an enzyme while retaining activity can be obtained.

### 3. Third Embodiment

### Biofuel Cell

Next, the third embodiment will be explained. In the third embodiment, the enzyme immobilization electrode according to the second embodiment is used as a positive electrode and a negative electrode of a biofuel cell.

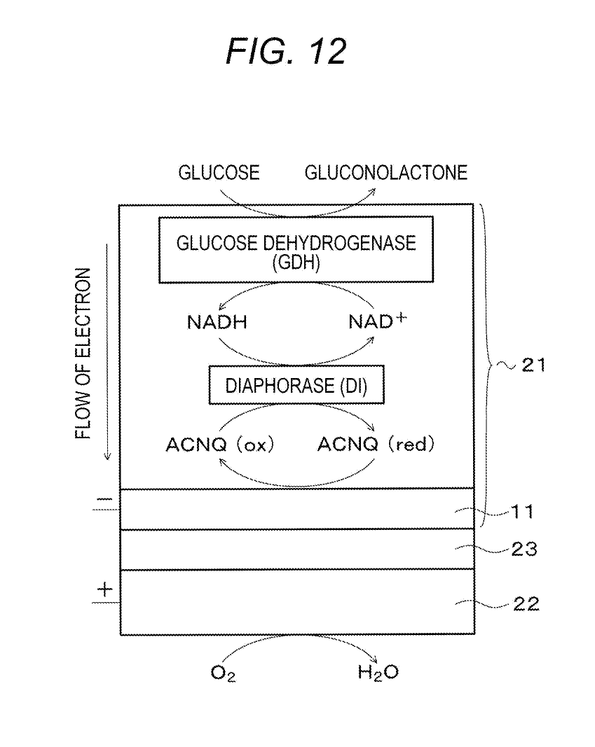

FIG. 11 schematically illustrates the biofuel cell. In the biofuel cell, glucose is used as a fuel. FIG. 12 schematically illustrates details of a configuration of a negative electrode of the biofuel cell, and one example of an enzyme group and a coenzyme immobilized on the negative electrode and a delivery reaction of an electron by the enzyme group and coenzyme.

As illustrated in FIGS. 11 and 12, the biofuel cell has a structure in which a negative electrode 21 and a positive electrode 22 face each other with an electrolyte layer 23 interposed therebetween. The negative electrode 21 degrades glucose supplied as a fuel using an enzyme, extracts an electron and generates a proton (H⁺). The positive electrode 22 generates water by a proton transported through the electrolyte layer 23 from the negative electrode 21 and an electron through an external circuit from the negative electrode 21 and, for example, oxygen in the air.

As the negative electrode 21, the enzyme immobilization electrode according to the second embodiment is used. An enzyme which is involved in degradation of glucose, a coenzyme from which a reductant is generated with oxidation reaction in a degradation process of glucose, and a coenzyme oxidase which oxidizes the reductant of the coenzyme are immobilized on the enzyme immobilization electrode. An electron mediator which receives from the coenzyme oxidase an electron generated with oxidation of the coenzyme and delivers the electron to the electrode for production of an enzyme immobilization electrode 10 is also immobilized on the electrode for production of an enzyme immobilization electrode 10 as necessary.

As the enzyme which is involved in degradation of glucose, for example, glucose dehydrogenase (GDH), preferably NAD dependent-type glucose dehydrogenase can be used. By causing the oxidase to exist, for example, β-D-glucose can be oxidized to D-glucono-δ-lactone.

Further, the D-glucono-δ-lactone can be degraded to 2-keto-6-phospho-D-gluconate by causing two enzymes: gluconokinase and phosphogluconate dehydrogenase (PhGDH) to exist. That is, D-glucono-δ-lactone is hydrolyzed into D-gluconate, and D-gluconate is phosphorylated into 6-phospho-D-gluconate by hydrolyzing adenosine triphosphate (ATP) into adenosine diphosphate (ADP) in the presence of gluconokinase. The 6-phospho-D-gluconate is oxidized into 2-keto-6-phospho-D-gluconate under action of the oxidase PhGDH.

Glucose can also be degraded to CO₂ using glucose metabolism in addition to the above-described degradation process. The degradation process using glucose metabolism is broadly classified into degradation of glucose and generation of pyruvic acid, and the TCA cycle, and they are widely well-known reaction systems.

Oxidation reaction in the degradation process of a monosaccharide is carried out with reduction reaction of a coenzyme. The coenzyme mostly depends on an acting enzyme, and in the case of GDH, NAD⁺ is used as the coenzyme. That is, when β-D-glucose is oxidized to D-glucono-δ-lactone by action of GDH, NAD⁺ is reduced to NADH, so that H⁺ is generated.

Generated NADH is immediately oxidized to NAD⁺ in the presence of diaphorase (DI), so that two electrons and H⁺ are generated. Accordingly, two electrons and two H⁺s are generated per molecule of glucose in one stage of oxidation reaction. Total four electrons and four H⁺s are generated in two stages of oxidation reaction.

The electron generated in the above-described process is delivered from diaphorase through the electron mediator to the electrode for production of an enzyme immobilization electrode 10, and H⁺ is transported to the positive electrode 22 through the electrolyte layer 23.

Preferably the above-described enzyme, coenzyme and electron mediator are kept at pH optimum to the enzyme, for example at around pH 7 by a buffer solution such as a phosphate buffer solution or tris buffer solution contained in the electrolyte layer 23 in order to ensure that electrode reaction is efficiently and regularly carried out. As the phosphate buffer solution, for example, NaH PO₄ or KH₂PO₄ is used. Further, an either excessively high or excessively low ionic strength (I.S.) has negative influences on enzyme activity, and when electrochemical reaction responsiveness is also considered, a moderate ionic strength of, for example, about 0.3 is preferable. However, the pH and ionic strength vary in optimum value depending on an enzyme to be used, and are not limited to the values described above.

FIG. 12 illustrates as one example a case where the enzyme which is involved in degradation of glucose is glucose dehydrogenase (GDH), the coenzyme from which a reductant is generated with oxidation reaction in the degradation process of glucose is NAD⁺, the coenzyme oxidase which oxidizes NADH, a reductant of the coenzyme is diaphorase (DI), and the electron mediator which receives from the coenzyme oxidase an electron generated with oxidation of the coenzyme and delivers the electron to the electrode for production of an enzyme immobilization electrode 10 is ACNQ.

As the positive electrode 22, the enzyme immobilization electrode according to the second embodiment is used. An oxygen reductase such as bilirubin oxidase, laccase or ascorbic acid oxidase is immobilized on this enzyme immobilization electrode. Preferably, in addition to the oxygen reductase, an electron mediator which performs reception and delivery of an electron with the positive electrode 22 is also immobilized on the positive electrode 22.

In the positive electrode 22, oxygen in the air is reduced by H⁺ from the electrolyte layer 23 and an electron from the negative electrode 21 in the presence of the enzyme which degrades oxygen, so that water is generated.

The electrolyte layer 23 is intended to transport H⁺ generated in the negative electrode 21 to the positive electrode 22, and is formed of a material that does not have electron conductivity and can transport H⁺. As the electrolyte layer 23, specifically one that is previously mentioned, such as cellophane, is used.

When glucose is supplied to the negative electrode 21 side in the biofuel cell configured as described above, the glucose is degraded by a degrading enzyme including an oxidase. As the oxidase is involved in the degradation process of the monosaccharide, an electron and H⁺ can be generated on the negative electrode 21 side, so that a current can be generated between the negative electrode 21 and the positive electrode 22.

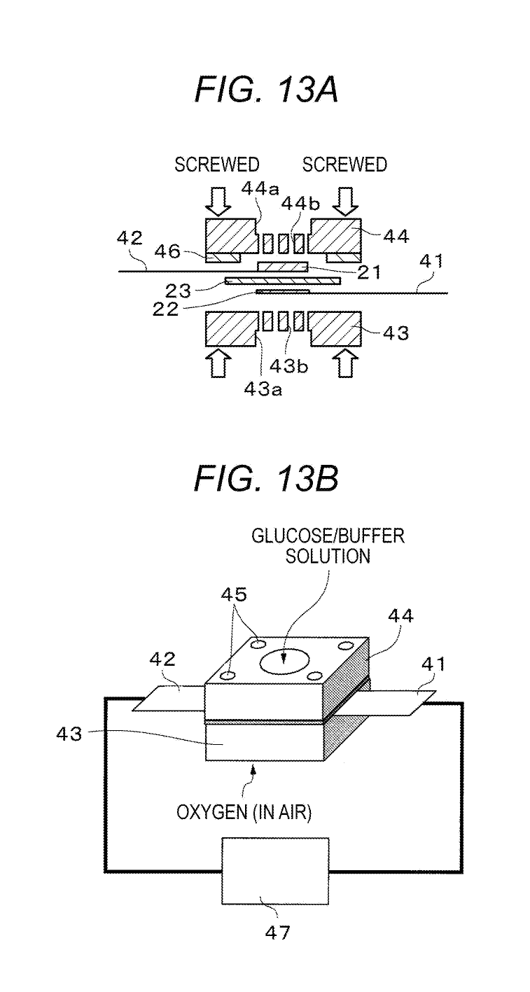

Next, an example of a specific structure of the biofuel cell will be explained. As illustrated in FIGS. 13A and 13B, the biofuel cell has a configuration in which the negative electrode 21 and the positive electrode 22 face each other with the electrolyte layer 23 interposed therebetween. In this case, Ti current collectors 41 and 42 are placed under the positive electrode 22 and under the negative electrode 21, respectively, so that current collection can be easily performed. Reference signs 43 and 44 each denote a fixing plate. These fixing plates 43 and 44 are fastened together by a screw 45, and the positive electrode 22, the negative electrode 21, the electrolyte layer 23 and Ti current collectors 41 and 42 are wholly held therebetween. One surface (outside surface) of the fixing plate 43 is provided with a circular concave portion 43a for entrapment of air, and the bottom surface of the concave portion 43a is provided with a large number of holes 43b extending through to the other surface. These holes 43b serve as a channel for supply of air to the positive electrode 22. On the other hand, one surface (outside surface) of the fixing plate 44 is provided with a circular concave portion 44a for loading of air, and the bottom surface of the concave portion 44a is provided with a large number of holes 44b extending through to the other surface. These holes 44b serve as a channel for supply of fuel to the negative electrode 21. The peripheral portion of the other surface of the fixing plate 44 is provided with a spacer 46, so that when the fixing plates 43 and 44 are fastened together by the screw 45, the gap therebetween is a predetermined gap.

As illustrated in FIG. 13B, a load 47 is connected between Ti current collectors 41 and 42, and a glucose solution obtained by dissolving glucose in, for example, a phosphate buffer solution is put in the concave portion 44a of the fixing plate 44 as a fuel to perform power generation.

### Example 10

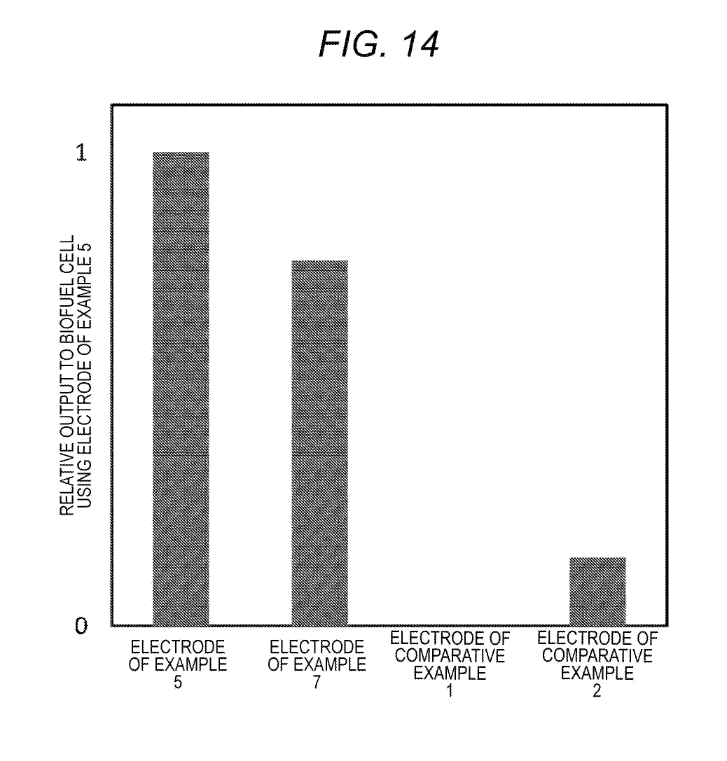

As the negative electrode 21, those obtained by fixing glucose dehydrogenase (GDH), diaphorase (DI) and NADH on the electrodes for production of an enzyme immobilization electrode 10 in Examples 5 and 7 and the electrodes for production of an enzyme immobilization electrode in Comparative Examples 1 and 2 were used. As the positive electrode 22, those obtained by immobilizing bilirubin oxidase (BOD) on the electrodes for production of an enzyme immobilization electrode 10 in Examples 5 and 7 and the electrodes for production of an enzyme immobilization electrode in Comparative Examples 1 and 2 were used. Outputs of biofuel cells using these positive electrodes 22 and negative electrodes 21 were measured. As a fuel solution, a glucose solution was used. FIG. 14 illustrates a relative output to the biofuel cell using the electrode for production of an enzyme immobilization electrode 10 in Example 5 after elapse of 1 hour after the biofuel cell is operated. From FIG. 14, it is apparent that biofuel cells using the electrodes for production of an enzyme immobilization electrode 10 in Examples 5 and 7 for the positive electrode 22 and negative electrode 21 exhibit high outputs as compared to biofuel cells using the electrodes for production of an enzyme immobilization electrode in Comparative Examples 1 and 2 for the positive electrode 22 and negative electrode 21.

According to the third embodiment, a high-output biofuel cell which is suitably used for power supplies of various kinds of electronic devices can be obtained.

The embodiments and Examples have been explained in detail above, but the present disclosure is not limited to the embodiments and Examples described above, and various modifications can be made.

For example, the numerical values, structures, configurations, shapes and materials or the like described in the embodiments and Examples described above are merely illustrative, and different numerical values, structures, configurations, shapes and materials or the like may be used as necessary.

The present technique can take the following constitutions.

[1] A biofuel cell including:

a positive electrode;

a negative electrode; and

a proton conductor provided between the positive electrode and the negative electrode,

wherein at least one of the positive electrode and the negative electrode is a mixture containing carbon particles and a water-insoluble hydrophilic binder and on which an enzyme is immobilized.

[2] The biofuel cell according to [1], wherein the binder includes at least one selected from the group consisting of ethyl cellulose, polyvinyl butyral, an acrylic resin and an epoxy resin.
[3] The biofuel cell according to [1] or [2], wherein the carbon particle includes at least one selected from the group consisting of carbon black, bio-carbon, vapor phase process carbon fiber and activated carbon.
[4] The biofuel cell according to any one of [1] to [3], wherein a ratio of a mass of the binder to a mass of carbon particles in the mixture is 0.01 or more and 1 or less.
[5] The biofuel cell according to any one of [1] to [4], wherein at least one of the positive electrode and the negative electrode is formed integrally with a separator provided between the positive electrode and the negative electrode.
[6] A method for production of a biofuel cell, wherein for producing a biofuel cell including:

a positive electrode;

a negative electrode; and

a proton conductor provided between the positive electrode and the negative electrode,

the method includes the steps of:

forming an electrode from a mixture containing carbon particles and a water-insoluble hydrophilic binder; and

forming at least one of the positive electrode and the negative electrode by immobilizing an enzyme on the electrode.

[7] The method for production of a biofuel cell according to [6], wherein a paste containing carbon particles and a binder is applied onto a substrate, and the paste is then solidified to format least one of the positive electrode and the negative electrode.
[8] The method for production of a biofuel cell according to [6] or [7], wherein a paste containing carbon particles and a binder is applied onto a separator, and the paste is then solidified to format least one of the positive electrode and the negative electrode integrally with the separator.

### REFERENCE SIGNS LIST

10 Electrode for production of an enzyme immobilization electrode
11 Substrate
12 Paste
14 Nonwoven fabric
21 Negative electrode
22 Positive electrode
23 Electrolyte layer
41, 42 Ti current collector
43, 44 Fixing plate

1. A biofuel cell comprising:
a positive electrode;
a negative electrode; and
a proton conductor provided between the positive electrode and the negative electrode,
wherein at least one of the positive electrode and the negative electrode is a mixture containing carbon particles and a water-insoluble hydrophilic binder and on which an enzyme is immobilized.

2. The biofuel cell according to claim 1, wherein the binder comprises at least one selected from the group consisting of ethyl cellulose, polyvinyl butyral, an acrylic resin and an epoxy resin.

3. The biofuel cell according to claim 2, wherein the carbon particle comprises at least one selected from the group consisting of carbon black, bio-carbon, vapor phase process carbon fiber and activated carbon.

4. The biofuel cell according to claim 1, wherein a ratio of a mass of the binder to a mass of carbon particles in the mixture is 0.01 or more and 1 or less.

5. The biofuel cell according to claim 1, wherein at least one of the positive electrode and the negative electrode is formed integrally with a separator provided between the positive electrode and the negative electrode.

6. A method for production of a biofuel cell, wherein for producing a biofuel cell comprising:
a positive electrode;
a negative electrode; and
a proton conductor provided between the positive electrode and the negative electrode,
the method comprises the steps of:
forming an electrode from a mixture containing carbon particles and a water-insoluble hydrophilic binder; and
forming at least one of the positive electrode and the negative electrode by immobilizing an enzyme on the electrode.

7. The method for production of a biofuel cell according to claim 6, wherein a paste containing carbon particles and a binder is applied onto a substrate, and the paste is then solidified to format least one of the positive electrode and the negative electrode.

8. The method for production of a biofuel cell according to claim 6, wherein a paste containing carbon particles and a binder is applied onto a separator, and the paste is then solidified to format least one of the positive electrode and the negative electrode integrally with the separator.

9. An electronic device,
the electronic device using one or plural fuel cells,
at least one fuel cell being a biofuel cell comprising:
a positive electrode;
a negative electrode; and
a proton conductor provided between the positive electrode and the negative electrode,
wherein at least one of the positive electrode and the negative electrode is a mixture containing carbon particles and a water-insoluble hydrophilic binder and on which an enzyme is immobilized.

10. An enzyme immobilization electrode, wherein an enzyme is immobilized on an electrode comprising a mixture containing carbon particles and a water-insoluble hydrophilic binder.

11. The enzyme immobilization electrode according to claim 10, which is formed on a separator integrally with the separator.

12. A method for production of an enzyme immobilization electrode, the method comprising the steps of:
forming an electrode from a mixture containing carbon particles and a water-insoluble hydrophilic binder; and
immobilizing an enzyme on the electrode.

13. The method for production of an enzyme immobilization electrode according to claim 12, wherein a paste containing carbon particles and a binder is applied onto a substrate, and the paste is then solidified to form the electrode.

14. The method for production of an enzyme immobilization electrode according to claim 12, wherein a paste containing carbon particles and a binder is applied onto a separator, and the paste is then solidified to form the electrode integrally with the separator.

15. An electrode for production of an enzyme immobilization electrode, which comprises a mixture containing carbon particles and a water-insoluble hydrophilic binder.

16. A method for production of an electrode for production of an enzyme immobilization electrode, wherein a paste containing carbon particles and a binder is applied onto a substrate, and the paste is then solidified to produce an electrode for production of an enzyme immobilization electrode.

17. An enzyme reaction using device comprising an enzyme immobilization electrode with an enzyme immobilized on an electrode comprising a mixture containing carbon particles and a water-insoluble hydrophilic binder.

18. The enzyme reaction using device according to claim 17, wherein the enzyme reaction using device is a biofuel cell, a biosensor or a bioreactor.
